(19) United States
(12) Patent Application Publication
(10) Pub. No.: US 2010/0175005 A1
(43) Pub. Date: Jul. 8, 2010

(54) INTERFACE FOR CHEMICAL PROCEDURE INFORMATION

(76) Inventors: J. Christopher Phelan, Wilmington, DE (US); David H. Silber, Wilmington, DE (US); Michael G.P. Reppy, Wilmington, DE (US)

Correspondence Address: CONNOLLY BOVE LODGE & HUTZ, LLP, P O BOX 2207, WILMINGTON, DE, 19899, US

(21) Appl. No.: 12/601,717

(22) PCT Filed: Mar. 26, 2008
(86) PCT No.: PCT/US08/58287

§ 371 Date: Nov. 24, 2009

Related U.S. Application Data
(60) Provisional application No. 60/908,083, filed on Mar. 26, 2007.

(51) Int. Cl. G06F 3/048

(52) U.S. Cl. 715/764

(57) ABSTRACT

A pocket-sized, portable computing apparatus that performs frequently used laboratory calculations, provides a look-up function for commonly used data and procedures, and provides note-taking and data capture for record-keeping. The present invention displays data in a form that a chemist finds most convenient and manipulates this data with functions a chemist typically utilizes in his work. In addition, the present invention provides a user interface that is compatible with traditional methods for formula manipulations and chemistry workflows and that increases the efficiency of the user in performing laboratory tasks.

### BACKGROUND OF THE INVENTION

The present invention generally relates to computer interfaces. In particular, embodiments of the invention provide methods for chemical information and processor-readable instructions for improving the efficiency of collecting information pertaining to chemical procedures in a laboratory setting.

The handling of information related to chemical reactions and the procedures used to accomplish them, including recording chemical structures, amounts of chemicals, manipulations of chemicals, chemical apparatus and physical conditions and treatments that induce or modify a chemical reaction is often a time-consuming and error-prone task. Chemists and other laboratory personnel working on complex chemical calculations, chemical experiments or chemical structures are made inefficient by the time and inconvenience associated with generating and processing of such information. In addition, errors are often introduced into the archival records about chemical procedures by the repeated transcriptions that take place when recording information using the methods available in the current state of the art.

In one background art method, E-Notebook available from CambridgeSoft, provides a smooth web-based interface designed to replace paper laboratory notebooks. E-Notebook pages contain Excel spreadsheets, Word documents, ChemDraw drawings and reactions and spectral data. However, this method requires a computer with a desktop operating system and is limited in scope in terms of meeting the users overall laboratory needs.

Therefore, there is a need in the art to provide methods that have increased capability in a portable form that would be available in the laboratory, and provide for a user's chemical data handling and recording requirements in a more user friendly application than those available in the background art.

### SUMMARY OF THE INVENTION

Embodiments of the invention provide a man-machine computer interface that captures information pertaining to chemical procedures in electronic form. Embodiments interact with a user through a physical interface that is mobile and can be easily transported to different work locations in the laboratory environment. Embodiments transform laboratory operations into electronic data representations with a semantically rich structure that facilitates later searching, manipulation and transformation of the data.

In one embodiment of the invention, a device for collecting information related to a chemical experiment comprises means for defining a set of semantic structures, values and types of information related to the chemical experiment; means for at least one of simultaneously and sequentially displaying a set of man-machine computer interface elements; means for controlling the display of man-machine computer interface elements with a set of processor-readable instructions that efficiently collect information from a user; means for defining relationships between chemical experiment procedural data and environmental parameters by a set of rules that are measurable without operator intervention; means for collecting information related to the chemical experiment procedures based upon changes in the environmental parameters; and means for transforming the information collected using the man-machine interface into a textual representation configured for record-keeping and publication.

In another embodiment of the invention, a device for collecting information related to a chemical experiment comprises means for at least one of simultaneously and sequentially displaying a set of man-machine computer interface elements; means for controlling the display of man-machine computer interface elements with a set of processor-readable instructions that efficiently collect information from a user; means for defining relationships between chemical experiment procedural data and environmental parameters without operator intervention by a set of rules; and means for collecting information related to the chemical experiment procedures based upon changes in the environmental parameters.

Another embodiment of the invention is a method for collecting information related to chemical experiment, comprising: defining a set of semantic structures, values and types of information related to the chemical experiment; displaying a set of man-machine computer interface elements simultaneously or sequentially within a physical interface; controlling the display of man-machine interface elements with a set of processor-readable instructions that efficiently collect information from a user; defining relationships between chemical experiment procedural data and environmental parameters by a set of rules that arc measurable without operator intervention, wherein the relations include, time and proximity to predetermined external objects that imply the chemical experiment procedural data; collecting information related to chemical experiment procedures based upon changes in the environmental parameters; controlling the display of the man-machine interface elements to determine chemical experiment procedural information that can be inferred from the semantic structures and previously collected data pertaining to the chemical experiment; and transforming the information collected using the man-machine interface into a textual representation configured for record-keeping and publication.

Another embodiment of the invention is a processor-readable medium containing processor erectable instructions that, when executed by a processor, causes the processor to implement a method for collecting information related to chemical experiment, comprising: defining a set of semantic structures, values and types of information related to the chemical experiment; displaying a set of man-machine computer interface elements that can be simultaneously or sequentially within a physical interface; controlling the display of man-machine interface elements with a set of processor-readable instructions that efficiently collect information from a user; defining relationships between chemical experiment procedural data and environmental parameters by a set of rules that are measurable without operator intervention, wherein the relations include, time and proximity to predetermined external objects that imply the chemical experiment procedural data; collecting information related to chemical experiment procedures based upon changes in the environmental parameters; controlling the display of the man-machine interface elements to determine chemical experiment procedural information that can be inferred from the semantic structures and previously collected data pertaining to the chemical experiment; and transforming the information collected using the man-machine interface into a textual representation configured for record-keeping and publication.

Preferably, embodiments of the invention provide capabilities that minimize the interactions required by a chemist to record data in electronic form. Embodiments capture, without additional interaction by the chemist, data that can be inferred in a rule-based manner from environmental parameters that can be retrieved or measured by the physical device in which it is implemented. For example, the amount of time elapsed between two experimental operations indicated by the chemist.

Preferably, based upon predetermined methods, embodiments of the invention spontaneously cue the chemist for interaction and data entry when appropriate. Embodiments provide the chemist with a context for additional data entry and with means for verifying the information and data that has been entered up to a given point in time. For example, on an ongoing basis, embodiments display the current state of the chemical information that has been captured regarding a particular chemical experiment.

Preferably, embodiments of the invention provide an interface for procedural information pertaining to chemical experiments that can be implemented in a mobile, portable or pocket-sized device comprising at least a processor capable of executing processor-readable instructions. Non-limiting examples include, but are not limited to: personal digital assistants and digital mobile phones.

Preferably, embodiments of the invention provide an interface for procedural information for chemical experiments in a physical device that is portable/mobile and yet can be temporarily affixed to a stationary surface in a convenient manner. Embodiments enable the user to enter information using only one hand either to press buttons or touch a physical interface with a tool, for example, but not limited to a stylus or other well known pointing devices.

Preferably, embodiments of the invention provide an interface for procedural information pertaining to chemical experiments using physical hardware and operating systems or libraries of software capable of responding to various means of input of data from the user. These means enable data entry by the user without the use of their hands or direct physical interface with the device. For example, these various means of inputs include, but are not limited to the voice of the user, radio frequency inputs, infrared means, Bluetooth® and other well known remote interfaces.

In the following, the invention will be described in detail with reference to some exemplifying embodiments of the invention illustrated in the figures in the accompanying drawing, the invention being by no means strictly confined to the details of the embodiments.

### BRIEF DESCRIPTION OF THE DRAWINGS

FIG. 1 is a schematic diagram depicting a user interface in accordance with the present invention;

FIG. 2 depicts a procedure interface form in accordance with the present invention;

FIG. 3 depicts a text note interface in accordance with the present invention;

FIG. 4 depicts an interface with control elements that mediates the collection of chemical amount information;

FIG. 5 is an exemplary flow diagram of a method for collecting information related to a chemical-of-interest by a sample panel;

FIG. 6. is an exemplary flow diagram of a method for collecting information related to a chemical reaction by a sample panel;

FIG. 7. depicts an alarm panel as it appears when no alarm exists in accordance with the present invention;

FIG. 8. depicts an alarm panel as it appears when an alarm exists in accordance with the present invention;

FIG. 9. depicts an agitation panel in accordance with the present invention;

FIG. 10 depicts a temperature panel in accordance with the present invention;

FIG. 11 depicts a work-up panel without any sub-panels displayed in accordance with the present invention;

FIG. 12. depicts a quench sub-panel in accordance with the present invention;

FIG. 13. depicts a wash sub-panel in accordance with the present invention;

FIG. 14. depicts a dry sub-panel in accordance with the present invention;

FIG. 15. depicts a concentrate sub-panel in accordance with the present invention; and

FIG. 16. depicts a purify sub-panel in accordance with the present invention.

### DETAILED DESCRIPTION OF PREFERRED EMBODIMENTS

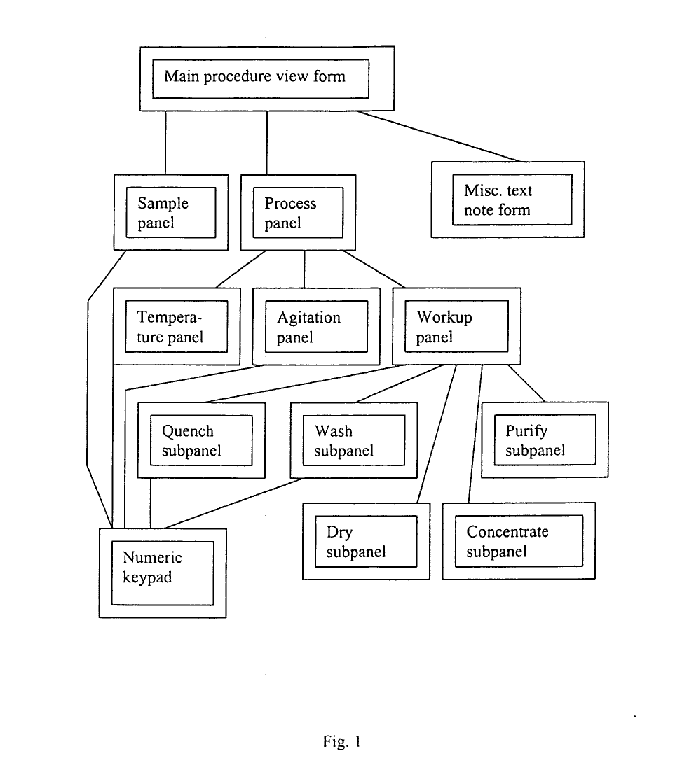

Embodiments of the invention comprise a method for a user interface that can be implemented using computer software on a portable device. The user interface, as shown in schematic form in FIG. 1 includes, but is not limited to, a main view, a set of subsidiary panels pertaining to individual chemicals that are part of a reaction, a set of subsidiary panels pertaining to the physical conditions to which a reaction is subjected, a set of subsidiary panels pertaining to the procedures used to isolate and purify the chemical product(s) resulting from a reaction and a set of subsidiary panels capable of capturing miscellaneous information outside the scope of any other panels.

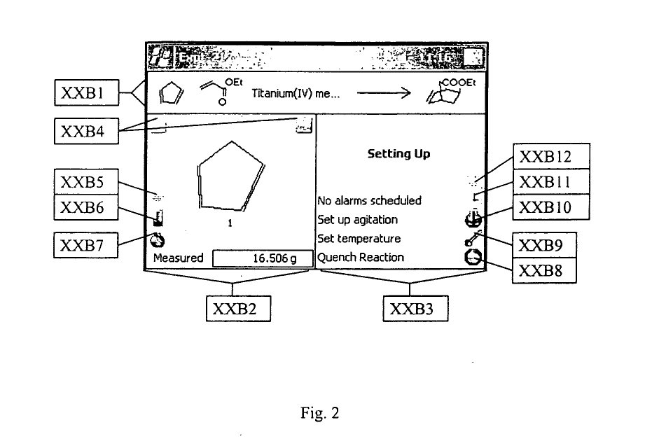

FIG. 2 shows an exemplary embodiment of the main view that includes display elements that present to the user a schematic of the chemical reaction (reaction panel XXB1), detailed information about one of the chemicals involved in the reaction (sample panel XXB2) and detailed information about the current physical conditions of the reaction (process panel XXB3); includes control elements (XXB1 and XXB4) by which the user can control which of the chemicals involved in a reaction are displayed in the sample panel XXB2; and also includes control elements (XXB5 through XXB12) that invoke the software functions controlling subsidiary panels and functions, specifically for adding a miscellaneous note pertaining to a specific chemical (XXB5), for measuring amounts of chemicals (XXB6), for adding chemicals to a reaction (XXB7), for specifying details of isolation and purification (XXB8), for specifying reaction temperature (XXB9), for specifying the agitation of a reaction mixture (XXB10), for setting or cancelling a reminder alarm for the reaction (XXB11) and for adding a miscellaneous note pertaining to the overall reaction (XXB12).

User interaction with the active control elements of the various panels and sub-panels of the interface causes the software code implementing the interface to collect data expressing the measurements and procedures performed by the user to achieve a particular chemical experiment. Upon collection, such data is stored by invoking software code that implements the data storage operation, which code stores the data in persistent memory on the mobile computer hardware on which it is implemented. This software code, without user intervention, structures the data in a fashion that reflects a hierarchical organization of the processes and parameters available to the user in performing chemical experiments.

User interaction with the representation of an individual chemical in the reaction panel XXB1 sends a signal to the software module controlling the sample panel XXB2 causing it to display information pertaining to the corresponding chemical. User interaction with the next and previous chemical icons XXB4 sends a signal to the software module controlling the sample panel XXB2 causing it to display information pertaining to the next or previous chemical in the ordered collection of chemicals pertaining to the reaction.

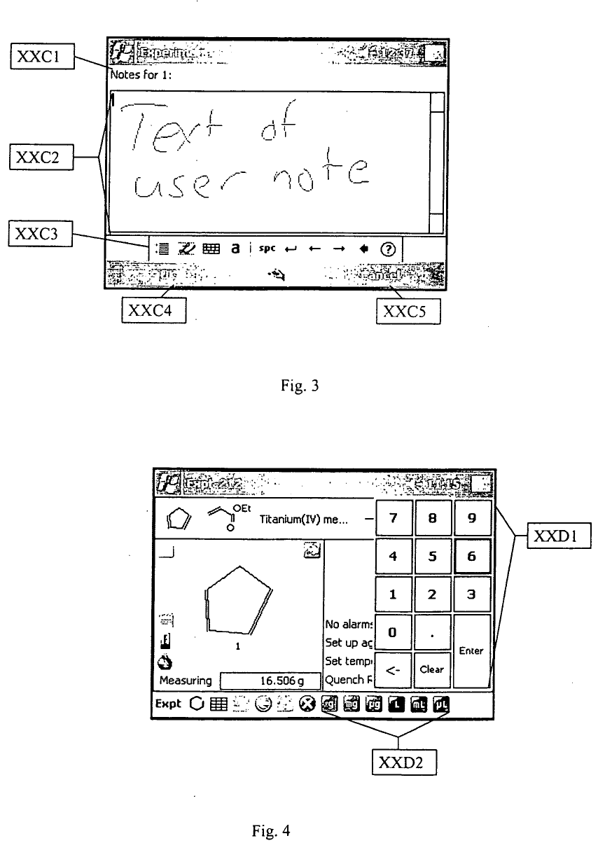

User interaction with the note icon XXB5 in the sample panel invokes software code that mediates the collection of text note information pertaining to the current chemical of interest with the text note interface shown in FIG. 3. This code renders the note interface visible, occluding all of the main view of the interface, with a caption display (XXC1) that provides the user with context as to which chemical in the reaction this note will pertain. The user then enters text in the main text area (XXC2) using any of the text interface methods implemented in the handheld computer of the embodiment, which are controlled by the affordances provided by the hand held device operating system (XXC3). The user signals completion of the note by interacting with the close button (XXC4), whereupon the text is stored in a fashion that associates it with the specific chemical selected in the sample panel and control is returned to the software code of the main procedure interface. The user may also signal that the note is to be discarded by interacting with the cancel button (XXC5), whereupon the text is not stored but control is also returned to the software code of the main procedure interface.

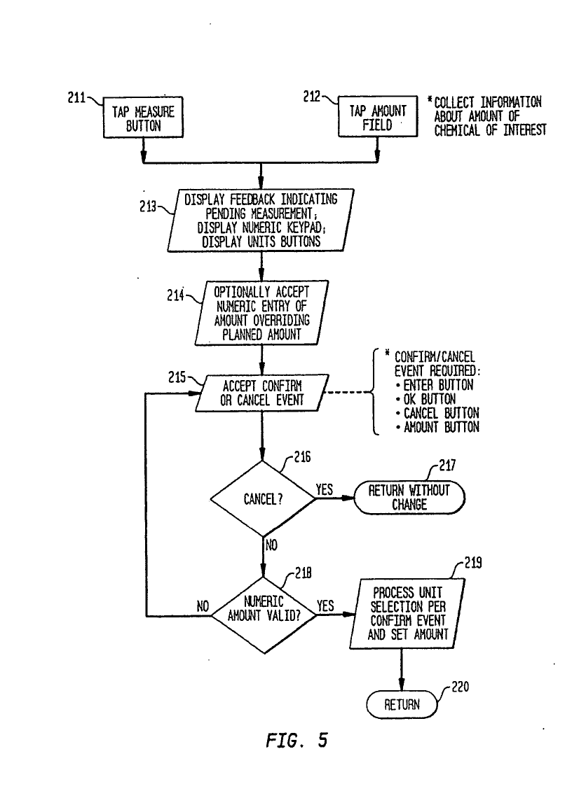

User interaction with the measure icon XXB6 or with the displayed numerical amount in the sample panel XXB2 invokes the software code that mediates the collection of amount information pertaining to the chemical selected in the sample panel. This software code displays additional active elements within the main view to achieve this end as shown in FIG. 4, specifically a numeric keypad (XXD1), which may occlude part or all of the process and reaction panels but which must not occlude the sample panel, and a group of control elements (XXD2) which enable the user to specify the units in which the chemical is being measured. User interactions with these control elements take place according to the flow diagram shown in FIG. 5.

FIG. 5 is an exemplary flow diagram detailing the flow of control in the software code implementing a method for collecting amount information related to a chemical-of-interest by the sample panel and the active elements described in paragraph [0037] (XXB2, XXB6, XXD1 and XXD2). In particular, in Step 211 and Step 212 of FIG. 5, the measure button and amount field, respectively are activated. Displaying feedback indicating pending measurement, a numeric keypad and other display buttons occurs in Step 213. Alternatively, a numeric entry of an amount other than the planned amount may be entered in Step 214. In Step 215, a determination is made of whether to accept, confirm or cancel. When cancellation is desired, a return to the calling routine without change occurs in Step 217. When cancellation is not desired in Step 218, a determination of whether a numeric amount is valid is determined. When the numeric amount is not valid, the routine returns to Step 214. When the numeric amount is determined, process units and confirming the event occurs in Step 219. Finally, the method returns to a calling routine in Step 210.

User interaction with the add chemical icon XXB7 invokes the software code that mediates the collection of information pertaining to the addition to the reaction of the chemical selected in the sample panel. This software code displays additional active elements, in particular a stop-add button, within the main view to achieve this end, according to the flow diagram shown in FIG. 6.

FIG. 6 is an exemplary flow diagram of a method for collecting information related to a chemical reaction by a sample panel. In particular, in Step 221 of FIG. 6, the add button is activated. In Step 223 a determination of whether a valid amount has been added is performed. When the amount is not valid, a measure routine occurs in Step 224 and a return the calling routine occurs in Step 220. When the amount is valid, recording start time; disabling the add button and enabling the stop-add button occurs in Step 225 and a return to the calling routine occurs in Step 226. In Step 227 of FIG. 6, the stop-add button is activated. In Step 228, recording stop time and disabling the stop-add button occurs in Step 228 and a return to the calling routine occurs in Step 229.

User interaction with the note icon XXB12 in the process panel invokes the software code that mediates the collection of text note information pertaining to the current chemical of interest with the text note interface shown in Figure XXC. This code renders the note interface visible, occluding all of the main view of the interface, with a caption display (XXC1) that provides the user with the context information that the note being entered will pertain to the whole reaction. The user then enters text in the main text area (XXC2) using any of the text interface methods implemented in the handheld computer of the embodiment, which are controlled by the affordances provided by the hand held device operating system (XXC3). The user signals completion of the note by interacting with the close button (XXC4), whereupon the text is stored in a fashion that associates it with the entire reaction being performed, the text note interface is made invisible once more and control is returned to the software code of the main procedure interface. The user may also signal that the note is to be discarded by interacting with the cancel button (XXC5), whereupon the text is not stored, but the text note interface is made invisible once more and control is also returned to the software code of the main procedure interface.

User interaction with the timer icon XXB11 in the process panel invokes the software code that enables the user to set or reset the alarm functionality of the device. This code renders the alarm interface visible, which may occlude part or all of the sample panel. The alarm panel software code takes one of two main pathways conditionally depending upon whether or not an alarm event is currently associated with the reaction being performed.

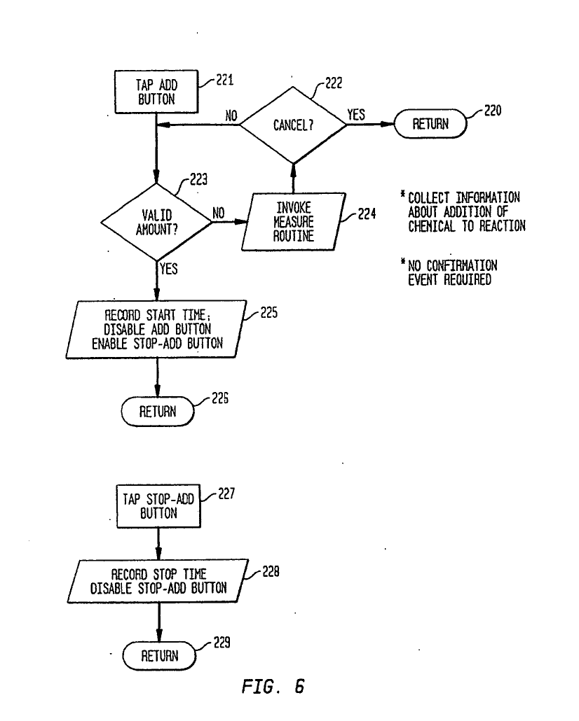

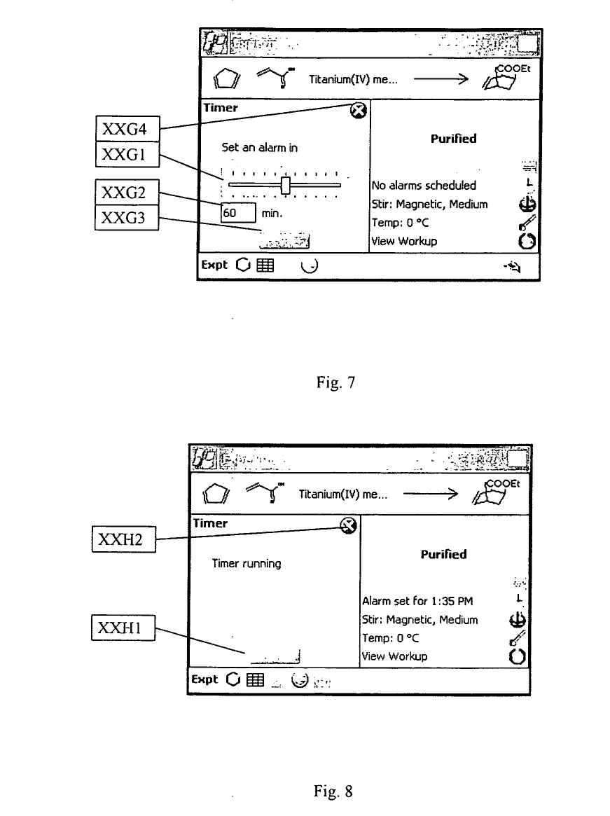

If there is no alarm event currently associated with the reaction being performed, the alarm interface appears as shown in FIG. 7. The user may specify the time to elapse before the alarm is triggered by interacting with the slider bar (XXG1) or the numeric entry box (XXG2); in the latter case the software code will invoke the numeric keypad interface code to collect a numeric value for the time desired by the user. The user must then confirm the setting of the alarm by interacting with the set button (XXG3), whereupon the software code will register an alarm event with the operating system software of the mobile device that will cause it to signal the application software code at the time specified by the user, and a signal is sent to the software code of the process panel causing it to display the time for which the alarm has been scheduled. Alternatively if the user does not wish an alarm to be set, he may cancel the process by interacting with the cancel button (XXG4). In either case the alarm panel is then made invisible once more and control is returned to the software code of the main procedure interlace.

If there is an alarm event currently associated with the reaction being performed, the alarm interface appears as in FIG. 8. User interaction with the reset button (XXH1) causes the software code to signal the operating system software to delete the alarm event associated with the reaction being performed, and a signal is sent to the software code of the process panel causing it to display that no alarm is scheduled for the current reaction. Alternatively, user interaction with the cancel button (XXH2) leaves the existing alarm event unchanged. In either case the alarm panel is then made invisible once more and control is returned to the software code of the main procedure interface.

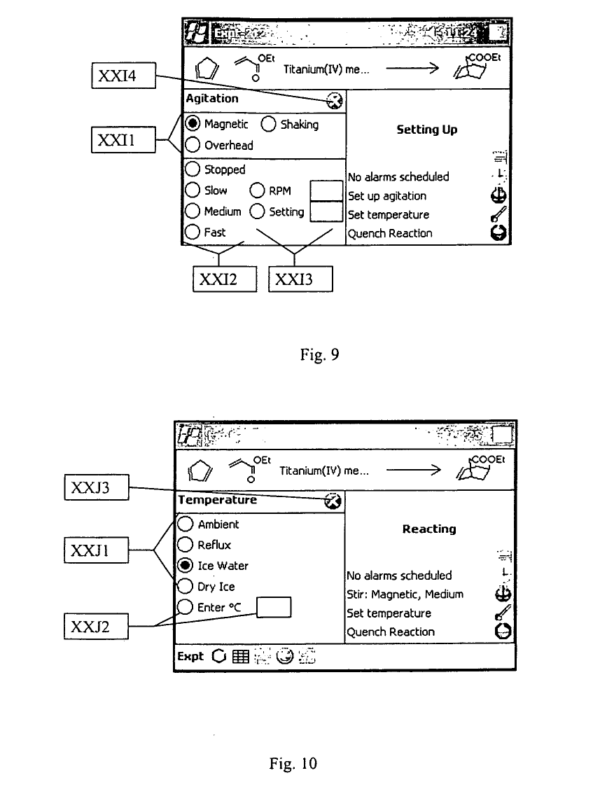

User interaction with the agitation button XXB10 invokes the software code that mediates collection of information about the agitation of the reaction mixture. This code renders the agitation panel visible, occluding part or all of the sample panel, as shown in FIG. 9, and pre-selects the most prevalent from among the specified values for agitation method. The user may optionally interact with any of several control elements pertaining to agitation method (XXI1), thereby causing the code to select the chosen agitation method for the reaction; failing such interaction, the pre-selected agitation method will be specified. The user may then interact with any of several control elements specifying a qualitative agitation speed (XXI2), causing the code to select the corresponding agitation speed, or may interact with any of several control elements specifying a quantitative agitation speed (XXI3), causing the code to invoke the numeric keypad interface code to collect a numeric value for the agitation speed. In either of these two cases, the software code will then store the specified agitation data, send a signal to the process panel causing it to display the same. Alternatively, the user may interact with the control element cancelling the specification of agitation method (XXI4), whereby no data will be stored and the process panel display will remain unchanged. In all cases the agitation panel will then be rendered invisible and control will be returned to the main procedure interface code.

User interaction with the temperature button XXB9 invokes the software code that mediates collection of information about the temperature of the reaction mixture. This code renders the temperature panel visible, occluding part or all of the sample panel, as shown in FIG. 10, and pre-selects the most prevalent from among the specified values for temperature. The user may then interact with any of several control elements each specifying a qualitative reaction temperature (XXJ1), causing the code to select the chosen temperature, or may interact with a control element specifying a quantitative temperature (XXJ2), causing the code to invoke the numeric keypad interface code to collect a numeric value for the temperature. In either of these two cases, the software code will then store the specified temperature data, send a signal to the process panel causing it to display the same. Alternatively, the user may interact with the control element cancelling the specification of temperature (XXJ3), whereby no data will be stored and the process panel display will remain unchanged. In all cases the temperature panel will then be rendered invisible and control will be returned to the main procedure interface code.

User interaction with the quench and workup button XXB8 invokes the software code that mediates collection and display of information about the quenching of the chemical reaction and the isolation and purification of the products thereof. This code renders the workup panel visible as shown in FIG. 11, occluding both the sample panel and the process panel, but not the reaction panel. The main area (XXK1) of the workup panel is devoted to the display of one of a series of sub-panels (shown in schematic form in Fig. XXA) each of which mediates collection of information about a particular aspect of this workup phase of the laboratory procedure. When the user interacts with any of a collection of selector control elements (XXK2), the software code renders the corresponding sub-panel visible and active. When the user interacts with the control element specifying navigation to the next sub-panel in the series (XXK3), the software code renders visible and active the subsequent sub-panel in a pre-defined sequential ordering of the sub-panels; this control element is rendered inactive when the last sub-panel in the sequence is displayed and active. When the user interacts with the control element specifying completion of data entry for the workup phase of the experiment (XXK4), the workup panel is rendered invisible again and control is returned to the software code of the main procedure view.

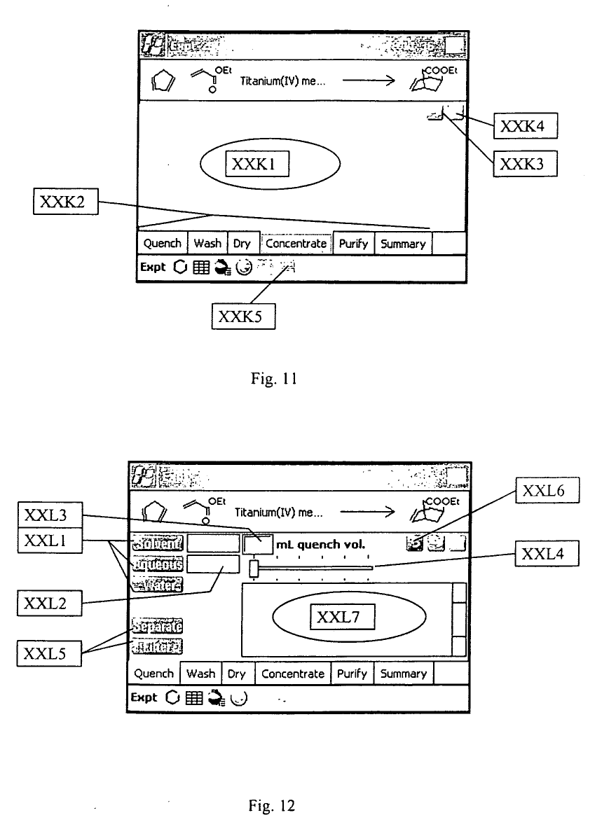

The software code pertaining to the quench sub-panel implements the user interface display and control elements required to interactively collect information pertaining to the methods by which chemical processes are stopped (quenched) during an experiment as shown in FIG. 12, including neutralizing agent addition buttons (XXL1), neutralizing agent descriptor boxes (XXL2), neutralizing agent volume box (XXL3) and slider (XXL4), physical procedure buttons (XXL5), undo button (XXL6) and quench step display area (XXL7). Upon initial display of the quench sub-panel each neutralizing agent descriptor box (XXL2) shows the identity of the agents referred to by the addition button (XXL1) to which the box is juxtaposed, the neutralizing agent volume box (XXL3) shows the volume of agent that will be recorded if no changes are made by the user, and the quench step display area (XXL7) shows any previous quench procedures that have been recorded pertaining to the reaction being performed.

User interaction with any of the several neutralizing agent buttons (XXL1), which pertain to quenching the reaction by adding a neutralizing substance to it, invokes the numeric keypad code to collect from the user the amount of neutralizing substance being added, or to confirm or change the default amount that was previously set and is displayed in the neutralizing agent volume box (XXL3). Following user confirmation of the numeric keypad entry (whether or not it has been modified), the software code stores the data regarding neutralizing agent identity and amount and adds a corresponding item to the list shown in the quench step display area.

User interaction with any of the several neutralizing agent descriptor boxes (XXL2), each of which pertains to the identity of the agent referred to by the addition button (XXL1) to which the box is juxtaposed, invokes a software code subroutine that shows a single-line text entry panel by which the user may enter a new identity for the corresponding neutralizing agent and with controls allowing the user to confirm or cancel the same, upon which the text entry panel is hidden. In the event the user confirms the modified quench agent identity, the modified identity is displayed in the descriptor box from which the code was invoked and future quench procedures recorded using the corresponding button are recorded using the new neutralizing agent identity; furthermore the software code described above in paragraph [0049] is invoked immediately using the new neutralizing agent identity, thus facilitating immediate recording of a quench procedure using the same.

User interaction with the neutralizing agent volume box (XXL3), which pertains to the volume of neutralizing substance to be recorded in a quench procedure, invokes the numeric keypad code to collect from the user the amount of neutralizing substance being added, or to confirm or change the default amount that was previously set and is displayed in the box. Upon user confirmation of a new amount, the amount in the box is updated, while upon user cancellation of the amount entry, the amount in the box is left unchanged; in either case control is returned to the software code of the main quench panel without recording any quench procedure data.

User interaction with the neutralizing agent slider bar (XXL4), which pertains to the volume of neutralizing substance to be recorded in a quench procedure, invokes software code that modifies the amount of neutralizing substance being added according to the slider position and displays the new amount in the neutralizing agent volume box (XXL3). When the slider is released by the user, control is returned to the software code of the main quench panel without recording any quench procedure data.

User interaction with any of the several physical procedure buttons (XXL5) invokes software code that immediately stores data regarding the physical procedure used to stop the reaction and adds a corresponding item to the list shown in the quench step display area. Control is then returned to the software code of the main quench panel.

User interaction with the quench panel undo button (XXL6) invokes software code that removes the most recently recorded data item from the stored collection of quench procedures for the reaction and removes the corresponding item from the list displayed in the quench step display area (XXL7). Control is then returned to the software code of the main quench panel.

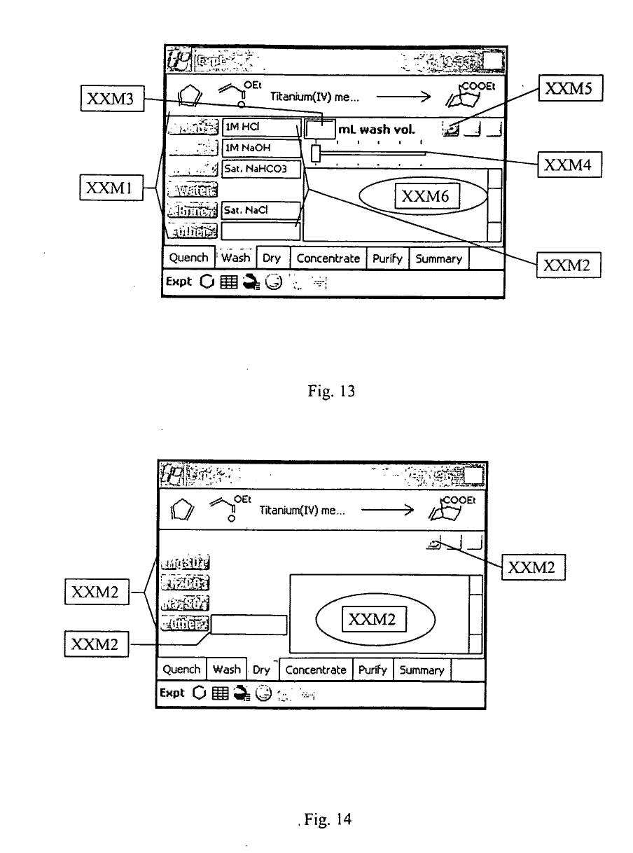

The software code pertaining to the wash sub-panel implements the user interface display and control elements required to interactively collect information pertaining to the methods by which chemical by-products are removed from the desired products by the interaction of immiscible liquid phases during an experiment, as shown in FIG. 13, including wash agent addition buttons (XXM1), wash agent descriptor boxes (XXM2), wash agent volume box (XXM3) and slider (XXM4), undo button (XXM5) and wash step display area (XXM6). Upon initial display of the quench sub-panel each wash agent descriptor box (XXM2) shows the identity of the agents referred to by the addition button (XXM1) to which the box is juxtaposed, the wash agent volume box (XXM3) shows the volume of agent that will be recorded if no changes are made by the user, and the wash step display area (XXM6) shows any previous wash procedures that have been recorded pertaining to the reaction being performed.

User interaction with any of the several wash agent buttons (XXM1), which pertain to removing chemical by-products from the reaction mixture by washing it with an immiscible liquid agent, invokes the numeric keypad code to collect from the user the amount of wash agent being added, or to confirm or change the default amount that was previously set and is displayed in the wash agent volume box (XXM3). Following user confirmation of the numeric keypad entry (whether or not it has been modified), the software code stores the data regarding wash agent identity and amount and adds a corresponding item to the list shown in the wash step display area.

User interaction with any of the several wash agent descriptor boxes (XXM2), each of which pertains to the identity of the agent referred to by the addition button (XXM1) to which the box is juxtaposed, invokes a software code subroutine that shows a single-line text entry panel by which the user may enter a new identity for the corresponding wash agent and with controls allowing the user to confirm or cancel the same, whereupon the text entry panel is hidden. In the event the user confirms the modified wash agent identity, the modified identity is displayed in the descriptor box from which the code was invoked and future wash procedures recorded using the corresponding button are recorded using the new wash agent identity; furthermore the software code described above in paragraph [0056] is invoked immediately using the new wash agent identity, thus facilitating immediate recording of a wash procedure using the same.

User interaction with the wash agent volume box (XXM3), which pertains to the volume of wash agent to be recorded in a wash procedure, invokes the numeric keypad code to collect from the user the amount of wash substance being added, or to confirm or change the default amount that was previously set and is displayed in the box. Upon user confirmation of a new amount, the amount in the box is updated, while upon user cancellation of the amount entry, the amount in the box is left unchanged; in either case control is returned to the software code of the main wash panel without recording any wash procedure data.

User interaction with the wash agent slider bar (XXM4), which pertains to the volume of wash agent to be recorded in a wash procedure, invokes software code that modifies the amount of wash agent being added according to the slider position and displays the new amount in the wash agent volume box (XXM3). When the slider is released by the user, control is returned to the software code of the main wash panel without recording any wash procedure data.

User interaction with the wash panel undo button (XXM5) invokes software code that removes the most recently recorded data item from the stored collection of wash procedures for the reaction and removes the corresponding item from the list displayed in the wash step display area (XXM6). Control is then returned to the software code of the main wash panel.

The software code pertaining to the dry sub-panel implements the user interface display and control elements required to interactively collect information pertaining to the methods by which water is removed from a solution of the desired products in an organic solvent by the action of a solid desiccant during an experiment, as shown in FIG. 14, including desiccant addition buttons (XXN1), user-programmable desiccant descriptor box (XXN2), undo button (XXN3) and dry step display area (XXN4). Upon initial display of the dry sub-panel the user-programmable desiccant descriptor box (XXN2) shows the identity of the desiccant referred to by the “Other” addition button (XXN1) to which the box is juxtaposed and the dry step display area (XXN4) shows any previous drying procedures that have been recorded pertaining to the reaction being performed.

User interaction with any of the several desiccant buttons (XXN1), which pertain to removing water from a solution of the desired products in an organic solvent by the action of a solid desiccant, invokes software code that immediately stores data regarding the desiccant used to stop the reaction and adds a corresponding item to the list shown in the dry step display area (XXN4). Control is then returned to the software code of the main dry panel.

User interaction with the user-programmable desiccant descriptor box (XXN2), which pertains to the identity of the desiccant referred to by the “Other” desiccant addition button (XXM1) to which the box is juxtaposed, invokes a software code subroutine that shows a single-line text entry panel by which the user may enter a new identity for the corresponding desiccant and with controls allowing the user to confirm or cancel the same, whereupon the text entry panel is hidden. In the event the user confirms the modified desiccant identity, the modified identity is displayed in the desiccant descriptor box and future dry procedures recorded using the corresponding button are recorded using the new desiccant identity; furthermore the software code described above in paragraph [0062] is invoked immediately using the new desiccant identity, thus facilitating immediate recording of a dry procedure using the same.

User interaction with the dry panel undo button (XXN3) invokes software code that removes the most recently recorded data item from the stored collection of dry procedures for the reaction and removes the corresponding item from the list displayed in the dry step display area (XXN4). Control is then returned to the software code of the main dry panel.

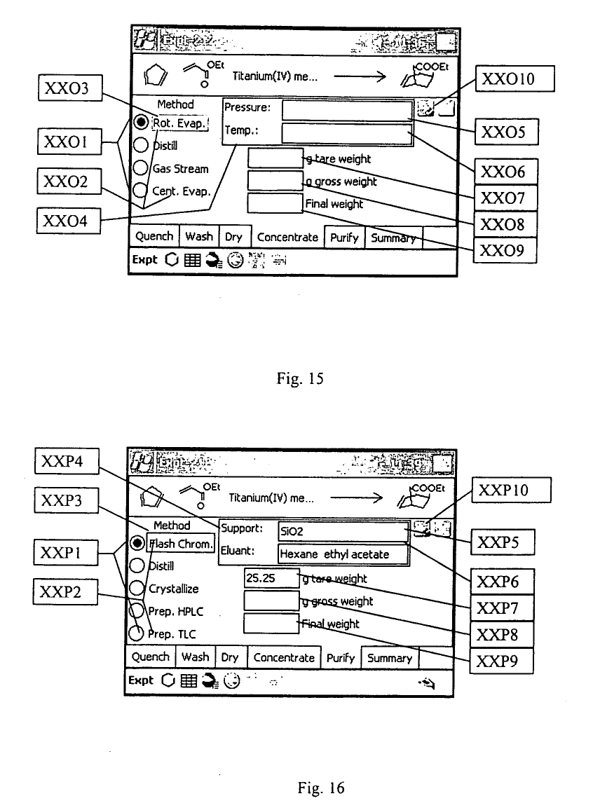

The software code pertaining to the concentrate sub-panel implements the user interface display and control elements required to interactively collect information pertaining to the methods by which solvents are removed from a solution of the desired products during an experiment, as shown in FIG. 15, including concentration method radio buttons (XXO1), concentration method captions (XXO2), pending concentration step indicator (XXO3), concentration detail sub-panel (XXO4) containing one or several entry boxes, crude tare weight box (XXO7), crude gross weight box (XXO8), crude net weight box (XXO9) and pending concentration step confirm-advance button (XXO10).

The software code pertaining to the concentration detail sub-panel implements the user interface display and control elements required to collect information pertaining to the detailed physical conditions under which solvents are removed from solutions, specifically a collection of concentration detail entry boxes. For concentration methods including rotary evaporation, distillation and centrifugal evaporation, these elements include the concentration pressure entry box (XXO5) and the concentration temperature entry box (XXO6) to collect information regarding pressure and temperature respectively. Alternatively, for concentration methods including evaporation in a stream of gas, these elements include the concentrating gas descriptor box (not shown). When the concentration detail sub-panel is displayed, this software code displays and activates only the boxes appropriate for the concentration procedure under consideration and their respective contents.

Upon initial display of the concentrate sub-panel when no pending concentrate step exists, the concentration method radio buttons (XXO1) are all unselected, the pending concentration step indicator (XXO3) is hidden, the concentration detail sub-panel and its entry boxes (XXO4, XXO5 and XXO6) are hidden, and the pending concentration step confirm-advance button (XXO10) is hidden while the standard advance button (XXK3) is displayed in its place.

Alternatively, upon initial display of the concentrate sub-panel when there exists a pending concentrate step that has previously been collected, the concentration method radio buttons (XXO1) are all unselected, the concentration method caption (XXO2) for the previously entered concentration method is displayed in a contrasting color, the pending concentration step indicator (XXO3) is hidden, the concentration detail sub-panel (XXO4) is visible along with its entry boxes (XXO5 and XXO6) each displaying any values previously entered into them, the crude tare weight box (XXO7) shows any previously entered crude tare weight, the crude gross weight box (XXO8) shows any previously entered crude gross weight, if any crude gross weight has been previously been entered the crude net weight box (XXO9) shows the crude net weight, and the pending concentration step confirm-advance button (XXO10) is hidden while the standard advance button (XXK3) is displayed in its place.

User interaction with any of the several concentration method radio buttons (XXO1) in the unselected state invokes the software code that collects information pertaining to the methods by which solvents are removed from a solution of the desired products during an experiment. This code marks the chosen concentration method radio button (XXO1) as selected, displays the pending concentration step indicator (XXO3) encircling the name of the selected method, renders the concentration detail sub-panel and its entry boxes (XXO4, XXO5 and XXO6) visible if they are not so already, and the concentration step confirm-advance button (XXO10) is displayed in place of the standard advance button (XXK3).

User interaction with any of the concentration detail entry boxes (e.g. XXO5 and XXO6) invokes software code that collects information about the value of that reaction variable by enabling the user to enter or edit the text of the box with any of the several text entry methods made available by the mobile device operating system. User confirmation of the datum by entering a “return” character or by interacting with a different control element of the procedure data interface causes the code to store the datum as part of the pending concentration procedure under consideration. If the confirmation event was interaction with a different control element, the code then also transfers control to that control element.

User interaction with the crude tare weight box (XXO7) invokes the numeric keypad code to collect from the user the tare weight of the vessel in which the reaction product solution is being concentrated, or to optionally change the tare weight that was previously set and is displayed in the box. Upon user confirmation of the entered weight, the weight in the box is updated, while upon user cancellation of the weight entry, the weight in the box is left unchanged; in either case the weight is stored as part of the pending concentration procedure under consideration and control is returned to the software code of the main concentrate panel.

User interaction with the crude gross weight box (XXO8) invokes the numeric keypad code to collect from the user the gross weight of the vessel with the reaction product after concentration, or to optionally change the gross weight that was previously set and is displayed in the box. Upon user confirmation of the entered weight, the weight in the box is updated, while upon user cancellation of the weight entry, the weight in the box is left unchanged; in either case the difference between the crude gross weight and the crude tare weight is computed and displayed in the crude net weight box (XXO9), the crude gross weight is stored as part of the pending concentration procedure under consideration and control is returned to the software code of the main concentrate panel.

User interaction with the concentration step confirm-advance button (XXO10) or with any of the workup tab selectors (XXK2) invokes software code that stores the pending concentration procedure and transfers control to the software code implementing the subsequent or the selected workup panel, respectively.

The software code pertaining to the purify sub-panel implements the user interface display and control elements required to interactively collect information pertaining to the methods by which the desired product is purified during an experiment, as shown in FIG. 16, including purification method radio buttons (XXP1), purification method captions (XXP2), pending purification step indicator (XXP3), purification detail sub-panel (XXP4) containing one or several entry boxes, purified tare weight box (XXP7), purified gross weight box (XXP8), purified net weight box (XXP9) and pending purification step confirm-advance button (XXP10).

The software code pertaining to the purification detail sub-panel implements the user interface display and control elements required to collect information pertaining to the detailed physical conditions pertaining to a particular purification method, specifically a collection of purification detail entry boxes. For chromatographic purification methods including flash chromatography, preparative high-performance liquid chromatography and preparative thin-layer chromatography, these elements include the purification chromatography support entry box (XXP5) and the purification chromatography eluant entry box (XXP6) to collect information regarding chromatographic support and eluant respectively. Alternatively, for purification methods including distillation, these elements include the distillation pressure entry box and the distillation temperature entry box (not shown, but identical in appearance to XXO5 and XXO6) to collect information regarding distillation pressure and temperature respectively. Alternatively, for purification methods including crystallization, these elements include the crystallization solvent entry box and the crystallization temperature entry box (not shown) to collect information regarding crystallization solvent and temperature respectively. When the purification detail sub-panel is displayed, this software code displays and activates only the boxes appropriate for the purification procedure under consideration and their respective contents.

Upon initial display of the purification sub-panel when no pending concentrate step exists, the concentration method radio buttons (XXP1) are all unselected, the pending purification step indicator (XXP3) is hidden, the purification detail sub-panel and its entry boxes (XXP4, XXP5 and XXP6) are hidden, and the pending purification step confirm-advance button (XXP10) is hidden while the standard advance button (XXK3) is displayed in its place.

Alternatively, upon initial display of the purification sub-panel when there exists a pending purification step that has previously been collected, the purification method radio buttons (XXP1) are all unselected, the purification method caption (XXP2) for the previously entered purification method is displayed in a contrasting color, the pending purification step indicator (XXP3) is hidden, the purification detail sub-panel (XXP4) is visible along with its entry boxes (XXP5 and XXP6) each displaying any values previously entered into them, the purified tare weight box (XXP1) shows any previously entered purified tare weight, the purified gross weight box (XXP8) shows any previously entered purified gross weight, if any purified gross weight has been previously been entered the purified net weight box (XXP9) shows the purified net weight, and the pending purification step confirm-advance button (XXP10) is hidden while the standard advance button (XXK3) is displayed in its place.

User interaction with any of the several purification method radio buttons (XXP1) in the unselected state invokes the software code that collects information pertaining to the methods by which the desired product is purified during an experiment. This code marks the chosen purification method radio button (XXP1) as selected, displays the pending purification step indicator (XXP3) encircling the name of the selected method, renders the purification detail sub-panel and its entry boxes (XXP4, XXP5 and XXP6) visible if they are not so already, and the purification step confirm-advance button (XXP10) is displayed in place of the standard advance button (XXK3).

User interaction with any of the purification detail entry boxes (e.g. XXP5 and XXP6) invokes software code that collects information about the value of that reaction variable by enabling the user to enter or edit the text of the box with any of the several text entry methods made available by the mobile device operating system. User confirmation of the datum by entering a “return” character or by interacting with a different control element of the procedure data interface causes the code to store the datum as part of the pending purification procedure under consideration. If the confirmation event was interaction with a different control element, the code then also transfers control to that control element.

User interaction with the purified tare weight box (XXP7) invokes the numeric keypad code to collect from the user the tare weight of the vessel in which the purified reaction product is being collected, or to optionally change the tare weight that was previously set and is displayed in the box. Upon user confirmation of the entered weight, the weight in the box is updated, while upon user cancellation of the weight entry, the weight in the box is left unchanged; in either case the weight is stored as part of the pending purification procedure under consideration and control is returned to the software code of the main purify panel.

User interaction with the purified gross weight box (XXP8) invokes the numeric keypad code to collect from the user the gross weight of the vessel with the purified reaction product, or to optionally change the gross weight that was previously set and is displayed in the box. Upon user confirmation of the entered weight, the weight in the box is updated, while upon user cancellation of the weight entry, the weight in the box is left unchanged; in either case the difference between the crude gross weight and the purified tare weight is computed and displayed in the purified net weight box (XXP9), the purified gross weight is stored as part of the pending purification procedure under consideration and control is returned to the software code of the main purify panel.

User interaction with the purification step confirm-advance button (XXP10) or with any of the workup tab selectors (XXK2) invokes software code that stores the pending purification procedure and transfers control to the software code implementing the subsequent or the selected workup panel, respectively.

During or subsequent to the collection of experiment procedure data by the software code implementing the interface, the user may request exportation of the data by interaction with a menu control element of the main view or by initiating a physical transfer of data from the mobile computer device on which the interface is implemented to another device where the data is required. Such a request for exportation invokes the software code that implements the translation of collected chemical data into human-readable text. This code iterates through the stored collection of chemical procedure data elements in chronological order. Each element is translated into natural language text along with the parameter values stored within it according to rules implemented in the software code according to each particular procedure element type. Additionally, text is generated pertaining to the time gaps between the elements, which text may be incorporated into the text clause pertaining to a procedure element adjacent to the elapsed time span or may be a free-standing text element, depending upon the length of the elapsed time span and upon the element types that bound the elapsed time span, according to rules implemented in the software code. The resulting text is returned by the software code to the calling routine for export and viewing by the user or transfer to another device where the data is required.

The foregoing description illustrates and describes the present invention. Additionally, the disclosure shows and describes only the preferred embodiments of the invention in the context of a method for increasing the yield of programmable logic devices, but, it is to be understood that the invention is capable of use in various other combinations, modifications, and environments and is capable of changes or modifications within the scope of the inventive concept as expressed herein, commensurate with the above teachings and/or the skill or knowledge of the relevant art.

The embodiments described herein above are further intended to explain the best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein and it is intended that the appended claims be construed to include alternative embodiments. In addition, the software code used to implement the above discussed embodiments is included in the appendix to the application.

What is claimed is:

1. A device for collecting information related to a chemical experiment comprising:
means for defining a set of semantic structures, values and types of information related to the chemical experiment;
means for at least one of simultaneously and sequentially displaying a set of man-machine computer interface elements;
means for controlling the display of man-machine computer interface elements with a set of processor-readable instructions that efficiently collect information from a user;
means for defining relationships between chemical experiment procedural data and environmental parameters without operator intervention by a set of rules;
means for collecting information related to the chemical experiment procedures based upon changes in the environmental parameters; and
means for transforming the information collected using the man-machine interface into a textual representation configured for record-keeping and publication.

2. The device according to claim 1 wherein the relationships between chemical experiment procedural data and environmental parameters comprise time and proximity to predetermined external objects that imply the chemical experiment procedural data.

3. The device according to claim 1 wherein the means for defining a set of semantic structures, the means for displaying a set of man-machine computer interface elements, means for controlling the display, means for defining relationships, means for collecting information and the transforming means comprise a mobile, portable or pocket sized device comprising at least a processor capable of executing processor-readable instructions.

4. The device according to claim 3 wherein the mobile, portable or pocket-sized device comprises at least one of a personal digital assistant and a digital mobile phone.

5. A device for collecting information related to a chemical experiment comprising:
means for at least one of simultaneously and sequentially displaying a set of man-machine computer interface elements;
means for controlling the display of man-machine computer interface elements with a set of processor-readable instructions that efficiently collect information from a user:
means for defining relationships between chemical experiment procedural data and environmental parameters without operator intervention by a set of rules; and
means for collecting information related to the chemical experiment procedures based upon changes in the environmental parameters.

6. The device according to claim 5 wherein the relationships between chemical experiment procedural data and environmental parameters comprise time and proximity to predetermined external objects that imply the chemical experiment procedural data.

7. The device according to claim 5 wherein the means for displaying a set of man-machine computer interface elements, means for controlling the display, means for defining relationships, and the means for collecting information comprise a mobile, portable or pocket sized device comprising at least a processor capable of executing processor-readable instructions.

8. The device according to claim 7 wherein the mobile, portable or pocket-sized device comprises at least one of a personal digital assistant and a digital mobile phone.

9. A method for collecting information related to chemical experiment, comprising:
defining a set of semantic structures, values and types of information related to the chemical experiment;
displaying a set of man-machine computer interface elements that can be simultaneously or sequentially within a physical interface;
controlling the display of man-machine interface elements with a set of processor-readable instructions that efficiently collect information from a user;
defining relationships between chemical experiment procedural data and environmental parameters by a set of rules without operator intervention, wherein the relations include, time and proximity to predetermined external objects that imply the chemical experiment procedural data;
collecting information related to chemical experiment procedures based upon changes in the environmental parameters;
controlling the display of the man-machine interface elements to determine chemical experiment procedural information that can be inferred from the semantic structures and previously collected data pertaining to the chemical experiment; and
transforming the information collected using the man-machine interface into a textual representation configured for record-keeping and publication.

10. The method according to claim 9 wherein the physical interface comprises at least one of a mobile, portable or pocket sized personal digital assistant and mobile phone.

11. The method according to claim 9 wherein the set of man-machine computer interface elements comprise at least one of a main view, a set of subsidiary panels pertaining to individual chemicals that are a part of a reaction, a set of subsidiary panels pertaining to the physical condition to which a reaction is subjected, a set of subsidiary panels pertaining to the procedures used to isolate and purify the chemical product(s) resulting from a reaction and a set of subsidiary panels capable of capturing miscellaneous information outside the scope of any other panels.

12. The method according to claim 11 wherein user interaction with the main view or the subsidiary panels invokes at least a portion of the set of processor-readable instructions.

13. A processor-readable medium containing processor executable instructions that, when executed by a processor, causes the processor to implement a method for collecting information related to chemical experiment, comprising:
defining a set of semantic structures, values and types of information related to the chemical experiment;
displaying a set of man-machine computer interface elements that can be simultaneously or sequentially within a physical interface;
controlling the display of man-machine interface elements with a set of processor-readable instructions that efficiently collect information from a user;
defining relationships between chemical experiment procedural data and environmental parameters without operator intervention by a set of rules, wherein the relations include, time and proximity to predetermined external objects that imply the chemical experiment procedural data:
collecting information related to chemical experiment procedures based upon changes in the environmental parameters;
controlling the display of the man-machine interface elements to determine chemical experiment procedural information that can be inferred from the semantic structures and previously collected data pertaining to the chemical experiment; and
transforming the information collected using the man-machine interface into a textual representation configured for record-keeping and publication.
